(19) United States
(12) Patent Application Publication
(10) Pub. No.: US 2008/0297693 A1
(43) Pub. Date: Dec. 4, 2008

(54) Lamp reflector with grounding portion and backlight module and liquid crystal display device with same

(75) Inventors: Yi-Fu Lin, Miao-Li (TW); Chih-Chung Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/810,406

(22) Filed: Jun. 4, 2007

(30) Foreign Application Priority Data
Jun. 2, 2007 (JP) 95119606

(51) Int. Cl. G02F 1/13357; F21V 7/00; F21V 8/00

(52) U.S. Cl. 349/65; 362/341; 362/609

(57) ABSTRACT

An exemplary backlight module includes a light guide plate, a light reflector, and a frame accommodating the light guide plate and the light reflector. The light reflector includes a main surface and a protruding portion provided at the main surface with the grounding portion configured for electrically connecting the lamp reflector with the frame. An exemplary liquid crystal display device using the backlight module is also provided.

### FIELD OF THE INVENTION

The present invention relates to a lamp reflector provided with an electrically grounding portion, a back light module including the lamp reflector, and a liquid crystal display device including the back light module.

### GENERAL BACKGROUND

Liquid crystal displays have become more and more popular because of their advantages such as low radiation, small size, and low power consumption. The maturity of liquid crystal display technology and innovations in the development of related technology have led to the liquid crystal display coming into widespread use in a number of diverse applications.

A liquid crystal display does not generate light by itself when it displays images. Instead, the liquid crystal display needs a source of light to accomplish the display. Typically, the source is a surface light source powered by electricity. The surface light source is generally a back light module, which includes a lamp, a light guide plate, and a frame that holds the lamp and the light guide plate. The light guide plate transforms light emitted by the lamp into substantially parallel light that illuminates the liquid crystal display. In addition, there is typically also a metallic lamp reflector provided around the lamp. The metallic lamp reflector prevents the light emitted by the lamp from scattering, and gathers the emitted light to enter the light guide plate. Usually, the lamp is supplied with electrical power via external electrical connectors. The metallic lamp reflector is a one-piece molded sheet, which is electrically grounded in order to prevent unnecessary accumulation of static electricity. Typically, the lamp reflector is grounded by an electrically conductive tape or by a screw, either of which electrically connects the lamp reflector with a bottom of the frame. However, the conductive tape or the screw is a separate additional piece. This adds to the steps needed to assemble the back light module, and adds to the overall cost of the back light module.

In view of the above-mentioned shortcomings, there is a need to provide a back light module that provides good performance, convenient assembly, and reduced costs. There is also a need to provide a liquid display device using such back light module.

### SUMMARY

An exemplary back light module includes a light guide plate, at least one lamp combination provided to face a light incident surface of the light guide plate, and a frame accommodating the light guide plate and the at least one lamp combination. The at least one lamp combination includes at least one lamp reflector and the exemplary back light module is provided with at least one of the following configurations. The first configuration is that the at least one lamp reflector comprises a grounding portion in contact with the frame and electrically connecting the at least one lamp reflector with the frame, and the second configuration is that the frame comprises a grounding portion in contact with the at least one lamp reflector and electrically connecting the at least one lamp reflector with the frame.

An exemplary liquid crystal display device includes a back light module and a liquid crystal panel provided adjacent to the back light module. The back light module includes at least one lamp reflector and a frame accommodating the at least one lamp reflector. The liquid crystal display device accomplishes grounding of the at least one lamp reflector of the back light module by using a grounding portion provided at the at least one lamp reflector or a grounding portion provided at the frame to electrically connect the at least one lamp reflector with the frame.

An exemplary lamp reflector includes a main surface, such as a bottom surface or a side surface, and a protruding grounding portion provided at the main surface with the grounding portion configured for electrically connecting the lamp reflector with a frame accommodating the lamp reflector.

There is no need for an extra connecting element in order to achieve grounding of a lamp reflector included in a back light module of a liquid crystal display device. This can simplify the process of manufacturing the back light module and the corresponding liquid crystal display device, and reduce manufacturing costs. Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a cross-sectional view of a back light module according to a first exemplary embodiment of the present invention.

FIG. 2 is a perspective, inverted view of a lamp reflector of the back light module of FIG. 1, showing two elastic fingers integrally formed as part of the lamp reflector.

FIG. 3 is a perspective, inverted view of a lamp reflector of a second exemplary embodiment of the present invention, showing two bulge portions integrally formed as part of the lamp reflector.

FIG. 4 is a perspective view of a lamp reflector according to an alternative embodiment of the present invention.

FIG. 5 is a cross-sectional view of a liquid crystal display device according to a third exemplary embodiment of the present invention, the liquid crystal display device including the back light module of FIG. 1.

### DETAILED DESCRIPTION OF PREFERRED EMBODIMENTS

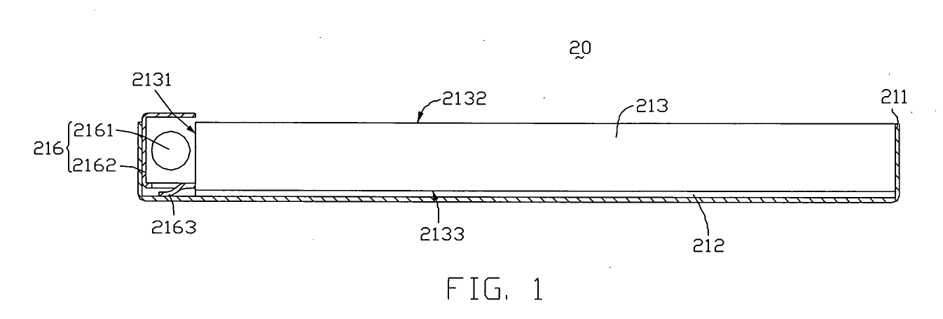

Referring to FIG. 1, a back light module 20 according to a first exemplary embodiment of the present invention includes a reflective plate 212, a light guide plate 213, a lamp combination 216, and a frame 211. The frame 211 accommodates the reflective plate 212, the light guide plate 213, and the lamp combination 216.

The light guide plate 213 has a light incident surface 2131, a light exit surface 2132 adjoining the light incident surface 2131, and a bottom surface 2133 at a side of the light guide plate 213 opposite from the light exit surface 2132. The reflective plate 212 is positioned underneath the bottom surface 2133, while the lamp combination 216 is positioned adjacent to the light incident surface 2131.

The lamp combination 216 is typically a bar-shaped assembly, which includes a lamp 2161 and a lamp reflector 2162 receiving the lamp 2161 therein. The lamp 2161 is typically an elongate lamp tube. The lamp combination 216 is positioned such that the lamp 2161 faces the light incident surface 2131. The lamp reflector 2162 is generally U-shaped. The lamp reflector 2162 has at least one bottom surface located above an inner bottom surface of the frame 211, and at least one side surface located adjacent to a corresponding at least one inner side surface of the frame 211. In the illustrated embodiment, the lamp reflector 2162 has one bottom surface and one side surface, with the bottom surface adjoining the side surface. The inner bottom surface of the frame 211 and the corresponding inner side surface of the frame 211 adjoin each other. In alternative embodiments, there can be two, three, or four bar-shaped lamp combinations 216.

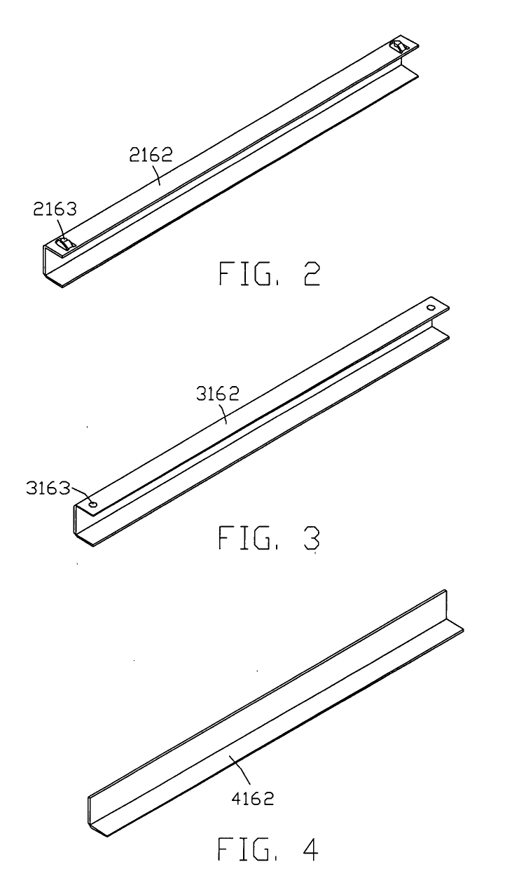

Referring also to FIG. 2, the lamp reflector 2162 includes at least one protruding grounding portion integrally formed therewith. The at least one protruding grounding portion electrically connects the lamp reflector 2162 with the frame 211. In the first exemplary embodiment, the at least one protruding grounding portion includes two elastic fingers 2163 provided at opposite ends of the bottom surface of the lamp reflector 2162 respectively. The elastic fingers 2163 resiliently press the inner bottom surface of the frame 211. Thereby, the lamp reflector 2162 is electrically connected with the frame 211, such that the lamp reflector 2162 is grounded.

Referring to FIG. 3, in an alternative embodiment, a lamp reflector 3162 according to a second exemplary embodiment of invention is shown. The lamp reflector 3162 has two bulge portions 3163 provided at opposite ends of a bottom surface thereof. When the lamp reflector 3162 is utilized in the above-described back light module 20, the bulge portions 3163 contact the inner bottom surface of the frame 211. Thereby, the lamp reflector 3162 is electrically connected with the frame 211, such that the lamp reflector 3162 is grounded.

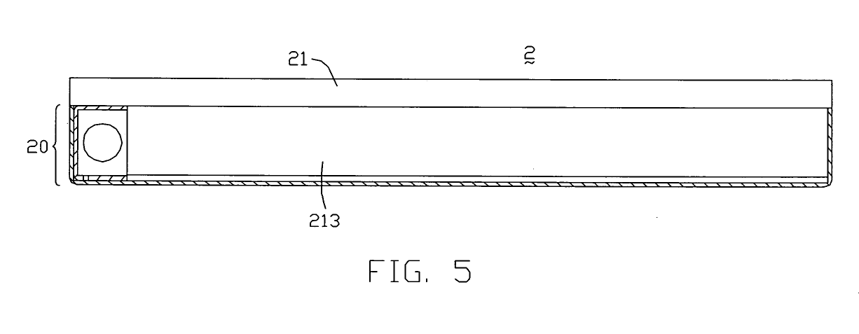

In further or alternative embodiments, the elastic fingers 2163 or the bulge portions 3163 can be integrally formed at the side surface of the lamp reflector 2162, the inner bottom surface of the frame 211, and/or the inner side surface of the frame 211. In a still further alternative embodiment as shown in FIG. 4, a lamp reflector 4162 is generally L-shaped. The lamp reflector 4162 has a bottom surface, a side surface, and a pair of elastic fingers (not visible) integrally formed at the bottom surface. When the lamp reflector 4162 is utilized in the above-described back light module 20, the bottom surface is located above the inner bottom surface of the frame 211, and the side surface is located adjacent to the corresponding inner side surface of the frame 211. Further, the lamp reflector 4162 is electrically connected with the frame 211 via the elastic fingers (not visible), such that the lamp reflector 4162 is grounded.

Referring to FIG. 5, a liquid crystal display device 2 according to a third exemplary embodiment of the present invention includes the back light module 20 and a liquid crystal panel 21. The liquid crystal panel 21 is provided above the light guide plate 213 of the back light module 20.

In summary, a back light module is provided with at least one integrally formed grounding portion. The at least one integrally formed grounding portion is provided as part of the lamp reflector and/or the frame of the back light module, and keeps the lamp reflector grounded. Thus, there is no need for an extra connecting element in order to achieve grounding of the lamp reflector. This can simplify the process of manufacturing the back light module and the corresponding liquid crystal display device, and reduce manufacturing costs.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms during which the appended claims are expressed.

What is claimed is:

1. A back light module, comprising:
a light guide plate having at least one light incident surface;
at least one lamp combination provided adjacent to the at least one light incident surface of the light guide plate, the at least one lamp combination comprising at least one lamp reflector; and
a frame accommodating the light guide plate and the at least one lamp combination;
wherein at least one of the following configurations is provided: the at least one lamp reflector comprises a grounding portion in contact with the frame and electrically connecting the at least one lamp reflector with the frame, and the frame comprises a grounding portion in contact with the at least one lamp reflector and electrically connecting the at least one lamp reflector with the frame.

2. The back light module as set forth in claim 1, wherein the grounding portion comprises an elastic finger.

3. The back light module as set forth in claim 1, wherein the grounding portion comprises a bulge portion.

4. The back light module as set forth in claim 1, wherein the at least one lamp reflector comprises a first surface opposing the frame, and a second surface adjacent to the first surface and opposing the frame.

5. The back light module as set forth in claim 4, wherein the grounding portion is provided at the first surface of the at least one lamp reflector.

6. The back light module as set forth in claim 4, wherein the grounding portion is provided at the second surface of the at least one lamp reflector.

7. The back light module as set forth in claim 4, wherein the frame comprises a first surface and a second surface adjacent to the first surface thereof, the first surface of the frame opposes the first surface of the at least one lamp reflector, and the second surface of the frame opposes the second surface of the at least one lamp reflector.

8. The back light module as set forth in claim 7, wherein the grounding portion is provided at the first surface of the frame.

9. The back light module as set forth in claim 7, wherein the grounding portion is provided at the second surface of the frame.

10. The back light module as set forth in claim 1, wherein the at least one lamp combination is generally U-shaped.

11. The back light module as set forth in claim 1, wherein the at least one lamp combination is generally L-shaped.

12. A liquid crystal display device, comprising:
a back light module comprising:
a light guide plate having at least one light incident surface;
at least one lamp combination provided adjacent to the at least one light incident surface of the light guide plate, the at least one lamp combination comprising at least one lamp reflector; and
a frame accommodating the light guide plate and the at least one lamp combination;
wherein at least one of the following configurations is provided: the at least one lamp reflector comprises a grounding portion in contact with the frame and electrically connecting the at least one lamp reflector with the frame, and the frame comprises a grounding portion in contact with the at least one lamp reflector and electrically connecting the at least one lamp reflector with the frame; and
a liquid crystal panel provided above the light guide plate of the back light module.

13. A lamp reflector, comprising:
a main surface; and
a protruding grounding portion provided at the main surface, the grounding portion configured for electrically connecting the lamp reflector with a frame accommodating the lamp reflector.
